(19) United States
(12) Patent Application Publication
(10) Pub. No.: US 2007/0203796 A1
(43) Pub. Date: Aug. 30, 2007

(54) RFID Advertisement and Purchase Information Dispersion Method

(76) Inventor: George Riggs III, Miami, FL (US)

Correspondence Address: GLEN RUSSELL STEVICK, 1636 WALNUT STREET, BERKELEY, CA, 94709, US

(21) Appl. No.: 11/671,279

(22) Filed: Feb. 5, 2007

Related U.S. Application Data
(60) Provisional application No. 60/777,798, filed on Feb. 28, 2006.

(51) Int. Cl. G06Q 20/00

(52) U.S. Cl. 705/18

(57) ABSTRACT

A business method that includes an RFID tag embedded into (1) a display advertisement (printed or illuminated) or (2) into a product with or without an RFID logo indicating the RFID presence. The display advertisement or product is communicated with by a user of a mobile communications unit (MCU) such as a cell phone. The RFID tag allows the user of the mobile communications unit to quickly obtain additional information regarding the advertised product or service (or unadvertised product or service) using an MCU. Additional information may include product specifications, dealer locations, and real time purchase or contract for services using the MCU (e.g. ordering ink for a printer or batteries for an electronic device). The RFID tag provides the necessary identification information to the user's MCU and retrieves the desired information from a remote server or database using the MCU, service provider, telephone system and/or the Internet. The mobile communications unit can identify the advertisement or product using the RFID and numerous communication protocols such as Bluetooth (such as described in Patent 6,895,221 hereby incorporated by reference) WiFi or other electromagnetic receive/transmit frequencies and protocols. Many different frequencies can be used. Today the most common are unlicensed low-frequency (in the range of 125 KHz), high-frequency (13.56 MHz), ultrahigh-frequency (902-928 MHz) and microwave (2.45 Mhz). Information and/or purchase capability can be stored on Internet available servers or databases maintained by the MCU service provider. Manufacturers, entertainment companies and service providers would purchase space on the server, control the information content provided to the user on demand and receive real time demographic, sales and survey information.

### CROSS REFERENCE TO RELATED APPLICATIONS

This application claims the benefit of PPA Ser. No. 11/671,279 by the present inventors, which is incorporated by reference and constitutes a replacement of said application filed on Feb. 05, 2007.

No. new matter is contained herein.

### FEDERALLY SPONSORED RESEARCH

not applicable

### SEQUENCE LISTING OR PROGRAM

not applicable

### BACKGROUND OF INVENTION

This invention relates to radio frequency identification tags (RFID) and the interactive use between product and consumer.

### BACKGROUND OF THE INVENTION PRIOR ACT

Many products have RFID tags imbedded in order to manage inventory, shipping or ownership and location. Exclusively, these methods involve a specific device for retrieving information from the product and thus make in not very usefull to interact with potential customers (see for instance Pat. No. 7,152,779).

A method exists which records information about the shopper who purchases an item but only if the shopper carries an approbriate RFID to make that connection (see for instance Pat. No. 7,156,303). This however only allows for more information for the producer and no additional information for the consumer.

In another method where interaction between product and consumer is allowed an elaborate special system is involved where the potential consumer has to directly interact with the product and then get information on a special computer system set up for this interaction (see for instance Pat. No. 7,156,289). This is a relatively high cost of interaction and only usefull for big ticket and highly specialized items. This system is not found in regular stores.

An RFID technology exists that limits the information strictly to price (see for instance Pat. No. 7,152,040). This technology is mostly used to facilitate check out and inventory control. This system does not allow for the potential customer to receive additional information if wanted.

### SUMMARY

A business method that includes an RFID tag embedded into (1) a display advertisement (printed or illuminated) or (2) into a product with or without an RFID logo indicating the RFID presence. The display advertisement or product is communicated with by a user of a mobile communications unit (MCU) such as a cell phone.

The RFID tag allows the user of the mobile communications unit to quickly obtain additional information regarding the advertised product or service (or unadvertised product or service) using an

MCU. Additional information may include product specifications, dealer locations, and real time purchase or contract for services using the MCU (e.g. ordering ink for a printer or batteries for an electronic device).

The RFID tag provides the necessary identification information to the user's MCU and retrieves the desired information from a remote server or database using the MCU, service provider, telephone system and/or the Internet.

The mobile communications unit can identify the advertisement or product using the RFID and numerous communication protocols such as Bluetooth (such as described in Patent 6,895,221 hereby incorporated by reference) WiFi or other electromagnetic receive/transmit frequencies and protocols. Many different frequencies can be used. Today the most common are unlicensed low-frquency (in the range of 125 KHz), high-frequency (13.56 MHz), ultrahigh-frequency (902-928 MHz) and microwave (2.45 Mhz).

Information and/or purchase capability can be stored on Internet available servers or databases maintained by the MCU service provider. Manufacturers, entertainment companies and service providers would purchase space on the server, control the information content provided to the user on demand and receive real time demographic, sales and survey information.

### DRAWINGS FIGURES

FIG. 1 shows an RFID system integrated into an MCU (cell phone) interacting with an RFID tag.

### DRAWINGS—REFERENCE NUMERALS

1. Product
2. MCU
3. Central data base about the product
4. Central data base can provide additional information via email, fax, etc. to customer.

### FIRST EMBODIMENT

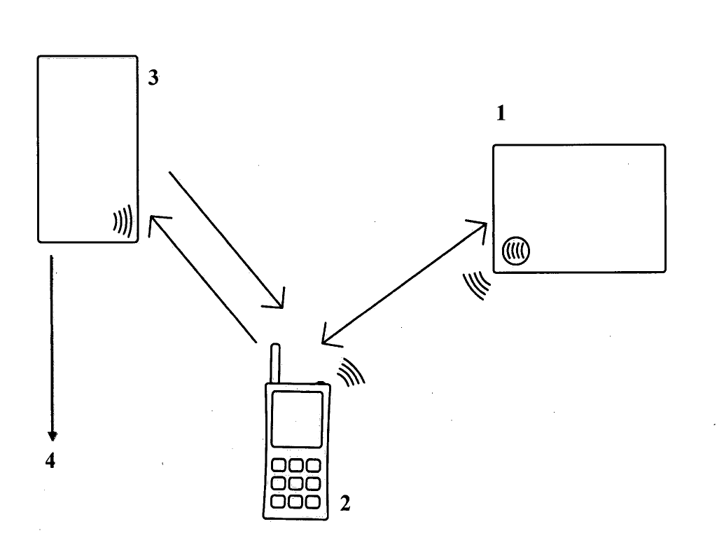

An Advertisement and Purchase Information Dispersion method (see FIG. 1) that includes an RFID tag embedded into a display advertisement (printed or illuminated) or into a product (1) with or without an RFID logo indicating the RFID presence. The display advertisement or product is communicated with by a user of a MCU (2). The RFID tag allows the user of MCU unit to quickly obtain additional information regarding the advertised product or service (or unadvertised product or service) using a MCU from a MCU service provider or internet database (3). Additional information may include product specifications, dealer locations, and real time purchase or contract for services using the MCU (e.g. ordering ink for a printer or batteries for an electronic device).

The RFID tag provides the necessary identification information to the user's MCU and retrieves the desired information from a remote server or database (4) using the MCU service provider, telephone system and/or the Internet.

The mobile communications unit can identify the advertisement or product using the RFID and numerous communication protocols such as Bluetooth (6,895,221), WiFi or other non-visible electromagnetic receiver/transmit methods and protocols. Information and/or purchase capabilities can be stored on Internet available servers or databases maintained by the MCU service provider.

### CONCLUSION, RAMIFICATION, SCOPE

The advantage of this invention is that a potential consumer can obtain information about a product on the spot on a familiar MCU such as the cell phone on which information can be stored for later retrieval. Additional advantages include the product effectively contacting the customer as she approaches the product and make itself noticed in an unprecedented way. This system provides:

1. A business method for providing advertisement, product, services and purchase information over any MCU using RFID tags embedded in advertisements and products. The RFID tag is read using the MCU (using any electromagnetic frequency) and the information is provided back to the MCU.

2. A business method according to claim 1 wherein the information is directed by the user to be provided via email to the users email which may or may not be available through the users MCU.

3. A business method according to claim 1 wherein the information is directed by the user to be provided via fax to a user provided fax number.

4. A business method according to claim 1 wherein the information is directed by the user to be provided via phone call to a voice mail system provided by the user.

5. A business method according to claim 1 wherein the information is stored in a data base maintained by the MDU service provider.

6. A business method according to claim 1 wherein the information is stored in a data base on a server accessible through the Internet.

7. A business method according to claim 1 wherein the product manufacturer or service provider pays a fee to have the information made available to a user on demand through hisher MCU.

8. A business method according to claim 1 wherein the product manufacturer or service provider is able to modify the provided information by logging into password and encryption protected server database.

9. A business method according to claim 1 wherein the product manufacturer or service provider is able to retrieve demographic, survey and/or purchase information from the server or data base in real time.

10. A business method according to claim 1 wherein the identification message is stored in the MCU (mobile telephone or PDA) and sent to a superordinate or database system as data messages over a standard mobile telephone speech channel using SMS, GSM standards or the Bluetooth channel of the mobile telephone.

11. A business method according to claim 1, wherein the communications unit includes an identification device which delivers information modulated and encoded in accordance with the Bluetooth standard or any other wireless electromagnetic receivtdtransmit protocol.

12. A business method according to claim 1, wherein the superordinate or database system downloads the assigned advertisement information, specification information, other information and/or supply ordering information (e.g. ink for a printer or batteries for an electronic device).

13. A business method according to claim 1, wherein the superordinate or database system downloads connects the MCU to an internet or telephone speech channel (wireless or hardwire) to provide advertisement information, specification information, other information and/or supply ordering information (e.g. ink for a printer or batteries for an electronic device).

14. A business method for providing advertisement, product, service and purchase information over any MCU initiating with the identification of the product or service via an RFID tag embedded in an advertisement or a product.

15. A business method wherein the RFID tag is read via the MCU with the aid of microwaves (2.45 GHz band) wherein the MCU irradiates the RFID identification device with microwaves, and wherein the identification device reflects information to the MDU by modulation of the incident microwave signal. The MCU comprises: a mobile telephone or PDA that includes a radio unit that operates with 2.45 GHz Bluetooth technology and that includes a Bluetooth channel, a baseband mixer between the radio unit of the Bluetooth channel and an antenna, wherein the MCU receives identification messages from said identification device.

16. A business method according to claim 15 wherein the identification message is stored in the MCU (mobile telephone or PDA) and sent to a superordinate or database system as data messages over a standard mobile telephone speech channel using SMS, GSM standards or the Bluetooth channel of the mobile telephone.

17. A business method according to claim 15, wherein the communications unit includes an identification device which delivers information modulated and encoded in accordance with the Bluetooth standard or any other wireless electromagnetic receiveltransmit protocol.

18. A business method according to claim 15, wherein the superordinate or database system downloads the assigned advertisement information, specification information, other information and/or supply ordering information (e.g. ink for a printer or batteries for an electronic device).

19. A business method according to claim 15, wherein the superordinate or database system downloads connects the MCU to an internet or telephone speech channel (wireless or hardwire) to provide advertisement information, specification information, other information andlor supply ordering information (e.g. ink for a printer or batteries for an electronic device).
